(19) United States
(12) Patent Application Publication
(10) Pub. No.: US 2017/0186323 A1
(43) Pub. Date: Jun. 29, 2017

(54) Vehicle Blind Spot Detection Device

(71) Applicant: Benjamin B. ATKIN, North Miami, FL (US)

(72) Inventor: Benjamin B. ATKIN, North Miami, FL (US)

(21) Appl. No.: 15/193,640

(22) Filed: Jun. 27, 2016

Related U.S. Application Data
(60) Provisional application No. 62/184,277, filed on Jun. 25, 2015.

(51) Int. Cl. G08G 1/16; G06K 9/00

(52) U.S. Cl. CPC G08G 1/167; G06K 9/00805

(57) ABSTRACT

A blind spot detection device is provided. The device features a power source, a camera operatively connected to the power source, a memory containing computer-readable instructions for determining whether an object is in a blind spot, a processor for executing the computer-readable instructions, a housing having a bottom and an outer surface, a status indicator disposed on the outer surface of the housing, and a removable attachment device disposed on the bottom of the housing. This device is capable of detecting an object in a driver's blind spot as well as notifying the driver.

### CLAIM OF PRIORITY

This application claims priority to U.S. Provisional Patent Application No. 62/184,277, filed on Jun. 25, 2015, entitled “Vehicle Blind Spot Detection Device”, the contents of which are hereby fully incorporated by reference.

### FIELD OF THE EMBODIMENTS

The invention broadly relates to a blind spot detection device, more specifically to an aftermarket vehicle blind spot detection device, and even more particularly to a device to detect blind spots in a driver's field of vision.

### BACKGROUND OF THE EMBODIMENTS

A driver sitting in the driver's seat of a vehicle has numerous blind spots while maneuvering a vehicle. The A-frames of the vehicle obstruct the driver's view when looking between the front windshield and side windows. More importantly, the driver does not have a complete field of vision to determine what is next to or behind the vehicle merely by looking at the side view mirrors while driving the vehicle. This creates a “blind spot” in the driver's ability to safely maneuver the vehicle. Due to this blind spot, a myriad of traffic accidents result because the driver simply did not see an object, e.g., another vehicle, in his blind spot.

Blind spots in the driver's field of vision cause avoidable traffic accidents. Examples of accidents include contact with other vehicles, pedestrians, or bicyclists, which often cause significant bodily harm and property damage. Due to these accidents, original equipment manufacturers (OEMs) have recently begun to integrate blind spot detection sensors into the side view mirrors of newly manufactured vehicles.

OEMs hard wire the electronics, sensors, and other warning system components for blind spot detection directly into newly constructed vehicles, depending on the vehicle's option package. For instance, luxury cars often provide an upgrade option for the consumer to obtain the benefit of blind spot detection. Blind spot detection is not standard in all vehicles at the current time. Although this option provides a significant safety improvement to some newly purchased and leased vehicles, existing vehicles on the road do not have the benefit of blind spot detection. A vast majority of existing vehicles on the road lack a sufficient device and system to detect and notify the driver of an object in his blind spot. Providing the driver advanced warning of such an obstruction will reduce the number of traffic accidents by informing the driver prior to a change in vehicle direction.

As can be derived from the variety of devices and methods directed at aftermarket blind spot detection, many means have been contemplated to accomplish the desired end, i.e., integrating the blind spot detection into the vehicle directly. Thus, there is a long-felt need for an independent blind spot detection device. There is a further long-felt need for a blind spot detection device that operates using its own power source.

Specific references to relevant prior art are herein described as follows:

U.S. Pat. No. 8,345,095 pertains to an apparatus for displaying an image of a blind spot area to which driver's view is obstructed by a pillar, includes: an monitor on the pillar; a camera to take an image of a peripheral area including the blind spot area; and an image converting device to convert the camera image and create an output image to be displayed on the monitor. The image converting device sets in the peripheral area a reference surface defined as a surface of a sphere around a reference point at which the driver's eye point is assumed to exist; obtains positions of intersecting points at which half-lines extending from the reference point and passing through respective screen pixels of the monitor intersect with the reference surface; identifies pixels of the camera image corresponding to the respective intersecting points based on the camera's parameters; and creates the output image using data of the identified pixels.

U.S. Pat. No. 8,083,386 pertains to an interior rearview mirror assembly includes a display device that includes a display screen and a plurality of illumination sources for backlighting the display screen. The display device is at least operable in (a) a first mode wherein the illumination sources are not activated so that the presence of the display device is substantially covert to a driver of the vehicle, (b) a second mode wherein the illumination sources are activated so that information displayed by the display screen is viewable by a driver of the vehicle, and (c) a third mode wherein (i) some of the illumination sources are activated so that information displayed by a corresponding backlit portion of the display screen is viewable by a driver of the vehicle and (ii) others of the illumination sources are non-activated so that the presence of a corresponding non-backlit portion of the display screen is substantially covert to the driver.

U.S. Pat. No. 7,852,462 pertains to a method for controlling a vehicular system based on the presence of an object in an environment around a vehicle with one goals being to prevent collisions between the vehicle and any objects. Infrared light is emitted from the vehicle into a portion of the environment around the vehicle and received by a sensor on the vehicle. Distance between the vehicle and an object from which the infrared light is reflected is determined based on the emission of the infrared light and reception of the infrared light. The presence of and an identification of the object from which light is reflected is/are determined based at least in part on the received infrared light. The vehicular system is controlled or adjusted based on the determination of the presence of an object in the environment around the vehicle and the identification of the object and the distance between the object and the vehicle.

U.S. Pat. No. 7,630,806 pertains to a system and method for reacting to an impact involving a motor vehicle in which an anticipatory sensor system assesses the probable severity of the impact based on data obtained prior to the impact and initiates deployment of an external safety device via an actuator in the event an impact above a threshold probable severity is assessed. The anticipatory sensor system includes receivers for receiving waves or energy and a pattern recognition system for analyzing the received waves or energy, or data representative thereof, to assess the probable severity of the impact. The pattern recognition system ascertains the identity of an object from which the waves or energy have been emitted, reflected or generated. The pattern recognition system includes a processor embodying a pattern recognition algorithm designed to provide an output of one of a number of pre-determined identities of the object.

U.S. Pat. No. 7,581,859 pertains to an exterior mirror sub-assembly includes a reflective element, a back plate, and a display element having a light source that is activatable to emit light. The display element attaches to a display receiving portion of the back plate and the light source is activatable to emit light through the display receiving portion. The display receiving portion may be configured to orient the display element at a predetermined angle so that light exiting the display element when the light source is activated may be directed (a) generally away from the vehicle when the mirror assembly is mounted to the vehicle so as to be principally viewed by drivers of other vehicles or (b) generally toward the driver of the vehicle when the mirror assembly is mounted to the vehicle so as to be principally viewed by the driver of the host vehicle.

U.S. Pat. No. 7,492,281 pertains to an exterior rearview mirror system for a vehicle includes an exterior mirror assembly that is mountable at an exterior side of a vehicle and has an inboard portion that is viewable by a driver of the vehicle when the mirror assembly is mounted at the exterior side of the vehicle. A blind spot indicator is disposed at the inboard portion of the mirror casing of the mirror assembly. The blind spot indicator comprises at least one illumination source for indicating to the driver a detected presence of an object alongside of and/or rearward of the vehicle. The indicator may comprise a unitary indicator module that is mountable at the inboard portion of the mirror assembly. The indicator module includes an illumination source and circuitry and is connectable to an electrical connector.

U.S. Pat. No. 7,209,221 pertains to a method for obtaining information about objects in an environment around a vehicle in which infrared light is emitted into a portion of the environment and received and the distance between the vehicle and objects from which the infrared light is reflected is measured. An identification of each object from which light is reflected is determined and a three-dimensional representation of the portion of the environment is created based on the measured distance and the determined identification of the object. Icons representative of the objects and their position relative to the vehicle are displayed on a display visible to the driver based on the three-dimensional representation. Additionally or alternatively to the display of icons, a vehicular system can be controlled or adjusted based on the relative position and optionally velocity of the vehicle and objects in the environment around the vehicle to avoid collisions.

U.S. Pat. No. 7,049,945 pertains to an arrangement for obtaining information about objects in an environment around a vehicle, e.g., in blind spots of the driver of the vehicle, including one or more light emitting components arranged on the vehicle for emitting infrared light into the environment around the vehicle and receivers arranged on the vehicle for receiving infrared light from the environment around the vehicle. The information about the objects is obtained based on analysis of the received infrared light by a processor, e.g., the distance between the vehicle and the object, the velocity of the object and the identity of the object. Pattern recognition techniques are preferably used to obtain the desired information. Control of the vehicle can be effected based on the detection of particular objects and their position and velocity, e.g., an audio or visual warning device or a steering wheel control device.

U.S. Pat. No. 6,927,677 pertains to a blind spot detector system adapted to the exterior of a vehicle comprising at least one infrared light emitting diode (LED), an infrared photodetector and demodulator, and a microcontroller. The output power of the infrared transmitter is linearly modulated, enabling the blind spot detector to determine the proximity of the detected object. Furthermore, the transmitter output is frequency modulated to screen out random infrared radiation that might adversely affect the operation of the infrared photodetector. The system is calibrated to the position of the attached vehicle by linearly increasing the output power of the transmitter until the rear quadrant of the vehicle is detected when the transmitter is outputting power at a pre-determined calibration level. During normal operation, an object detected while the transmitted power is greater than a predetermined lower threshold and less than the calibration level will activate a LED indicator on the system housing.

U.S. Pat. No. 6,744,353 pertains to a warning device for mounting onto a vehicle, in order to attract the attention of the driver when another vehicle (2) or object is located in a position that is wholly or partially critical for the driver. The device comprises two sources (5, 6) of laser radiation arranged at a distance from each other, a convex lens (8) arranged outside of each source and a position-sensitive radiation detector (7) arranged between the sources (5, 6). The device reacts with different levels of warning signals on the detection of direction indicator (58), angular deviation (60) of a wheel or the steering wheel, speed (62), etc., in combination.

U.S. Pat. No. 7,193,380 pertains to a method for rotating a printer paper-feed roller wherein the roller is driven by a DC (direct current) motor. A feedback-control signal is applied to the motor until the roller reaches a desired rotational position. The feedback-control signal is a function of an error signal, and the error signal represents the difference between the actual rotational position and the desired rotational position of the roller. When the roller reaches the desired rotational position, the applied feedback-control signal is removed from the motor, and a direct-control biasing signal is applied to the motor to reduce or prevent rollback of the roller when the feedback-control signal is removed from the motor. In one example, the signals are PWM (pulse-width-modulated) signals.

U.S. Pat. No. 4,694,295 pertains to a equentially operating dual sensor technology. The first sensor effort takes place as a photonic event. An infrared light emitting diode (IRLED) is coupled to an infrared sensitive phototransistor (PT) or photo-darlington (PD) through the reflectance of incident light energy from the target vehicle. Once detected, a preset time delayed switch is made which activates operation of the second sensor. The second sensor is ultrasonic. The vehicle operator is actually given the distance (in feet) between his vehicle and the threat obstacle.

Various devices are known in the art. However, their structure and means of operation are substantially different from the present disclosure. The other inventions fail to solve all the problems taught by the present disclosure. The present invention provides blind spot detection devices that can be added to a vehicle not originally equipped with that feature. At least one embodiment of this invention is presented in the drawings below, and will be described in more detail herein.

### SUMMARY OF THE EMBODIMENTS

The present invention provides for a blind spot detection device, comprising: a power source; a camera operatively connected to the power source; a memory containing computer-readable instructions for determining whether an object is in a blind spot; a processor for executing the computer-readable instructions; a housing having a bottom and an outer surface, wherein the camera, the memory, and the processor are contained within the housing; a status indicator disposed on the outer surface of the housing; a removable attachment device disposed on the bottom of the housing. Preferably, the camera is rotatable and has a field of view of 135 degrees, and can detect infrared light. In some embodiments, the present invention further comprises a proximity sensor. Also preferably, the present invention is mounted on an upper door paneling of an automobile. In some embodiments, the power source is located within the housing. In these embodiments, a charging port is preferably integrated into the housing and operatively connected to the power source, which is preferably a battery. Alternatively, the power source may be within an automobile, optionally accessed through the cigarette lighter standard in most automobiles. In other embodiments the present invention has at least one speaker and a wireless transceiver, allowing for communication with a mobile phone.

The present invention also provides for a blind spot detection device, comprising: a first and second detector, each comprising: a power source, a motion detector, a wireless transceiver, at least one speaker, at least one status light, a memory containing computer-readable instructions for detecting proximate objects, a processor for executing the computer-readable instructions; a display unit, comprising: a power source, a motion detector, a wireless transceiver, at least one speaker, at least one status light, a memory containing computer-readable instructions for interfacing with the first detector unit and the second detector unit; a processor for executing the computer-readable instructions; wherein the display unit is wirelessly connected to the first detector and the second detector. Preferably the first detector unit and the second detector unit are removably attached to a side of an automobile, and the display unit is removably attached to a windshield of an automobile. In another embodiment the display unit can indicate which side a proximate object is located on. In a highly preferred embodiment the device powers off after two minutes of use, and is powered on when motion is detected by the motion detector.

The present invention also provides for a method of notifying a driver of an object in a blind spot of the driver, comprising the steps of: providing, a blind spot detection device comprising: a power source, a camera operatively connected to the power source, a memory containing computer-readable instructions for determining whether an object is in a blind spot, a processor for executing the computer-readable instructions, a housing having a bottom and an outer surface, wherein the camera, the memory, and the processor are contained within the housing, a status indicator disposed on the outer surface of the housing, a removable attachment device disposed on the bottom of the housing; placing, the blind spot detection device on an upper door paneling of an automobile; sensing, by the blind spot detection device if an object is in the blind spot of a driver; notifying the driver, via the status indicator, that an object is in the blind spot. In these embodiments, the status indicator preferably notifies a driver by illuminating a light.

The present invention relates to an aftermarket vehicle blind spot detection device. For OEM installed blind spot detection systems, the driver is alerted through the use of a light or other indicator in the side view mirror or within the window frame. These locations keep the indicator within the driver's field of vision while the vehicle is in operation. Instead of an OEM integrated blind spot detection device installed within the vehicle, the present invention is installed inside a vehicle aftermarket, as an accessory. Millions of vehicles currently on the road are not equipped with blind spot detection devices. Moreover, only a select few vehicle models are equipped with the option package that includes a blind spot detection device.

The present invention meets and exceeds the following objectives:

It is an object of the present invention to improve safety.

It is an object of the present invention to reduce the number of automobile collisions.

### BRIEF DESCRIPTION OF THE DRAWINGS

FIG. 1 is a perspective, side, and front view of the blind spot detection device.

FIG. 2 is a perspective, side, and front view of a second embodiment of the present invention.

FIG. 3 is a perspective, side, and front view of a third embodiment of the present invention.

FIG. 4 is a positional view of the blind spot detection device.

FIG. 5 is a positional view of the second embodiment of the present invention.

FIG. 6 is a positional view of the third embodiment of the present invention.

FIG. 7 is a perspective view of yet another embodiment of the present invention.

FIG. 8 is a top view of an embodiment of the present invention in use on an automobile.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

While this disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof.

Therefore, it is intended that the disclosure not be limited to the particular embodiments disclosed.

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “vehicle” is synonymous with terms such as “car”, “truck”, “sport utility vehicle”, “hybrid”, “electric vehicle”, “van”, etc., and such terms may be used interchangeably as appearing in the specification and claims. Although any methods, devices or materials similar or equivalent to those described herein can be used in the practice or testing of the invention, the preferred methods, devices, and materials are now described.

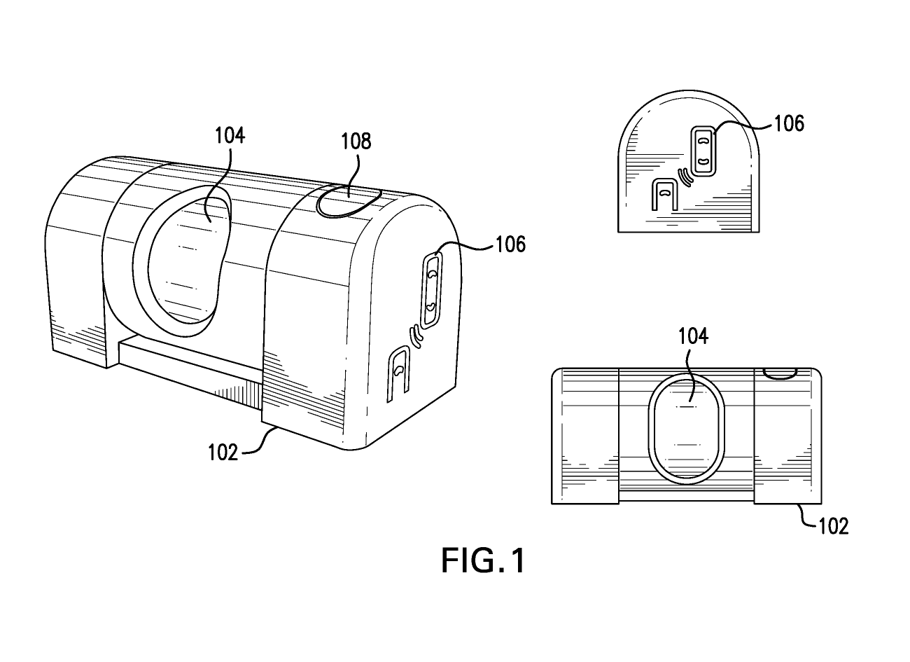

Referring to FIG. 1, the present invention includes housing 102 that is secured to the door surface inside the car. The bottom of housing 102 is secured to the vehicle. Housing 102 provides the structure and frame for the various components of the present invention, such as camera 104, status indicator 106, mute button 108, charging port 110, and the power source (not pictured). Here, camera 104 is enclosed within housing 102. Housing 102 includes an opening that provides camera 104 a viewpoint to detect objects within the driver's blind spot. Camera 104 is optimally positioned within the vehicle to detect driver blind spot objects based on the vehicle make, model, window position, height, and other factors. Camera 104 uses vision technology to identify blind spot objects. In example embodiments, device 100 utilizes radar, motion detector, night vision, light sensors, or any other sensor enabled technology instead of or in conjunction with camera 104 to detect objects within the driver's blind spot.

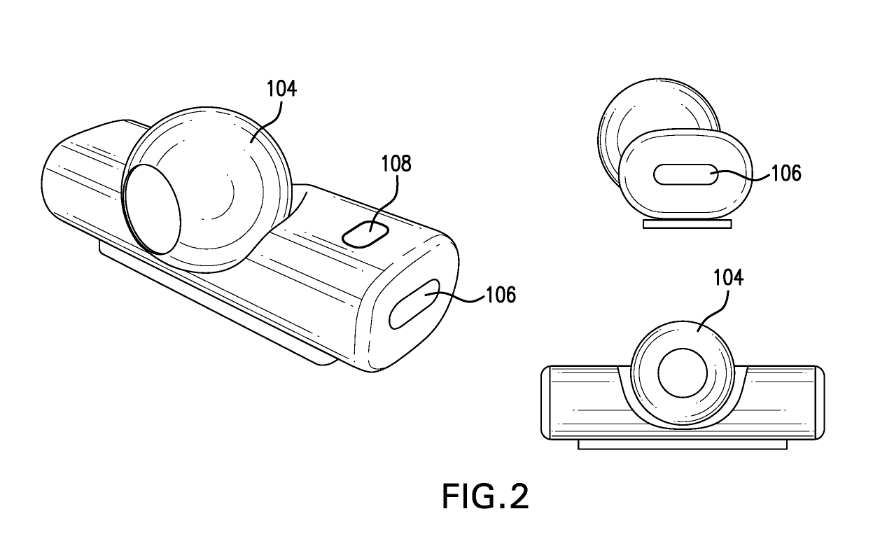

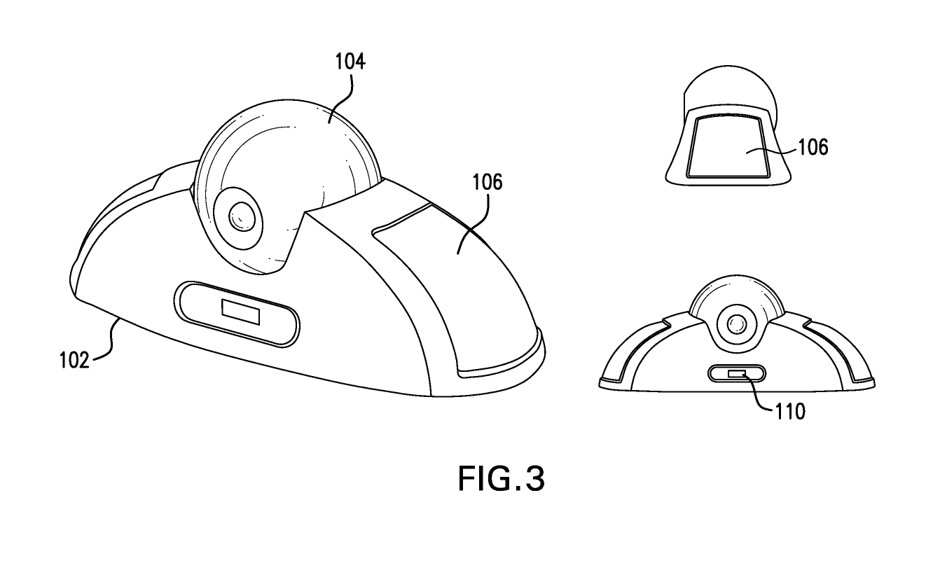

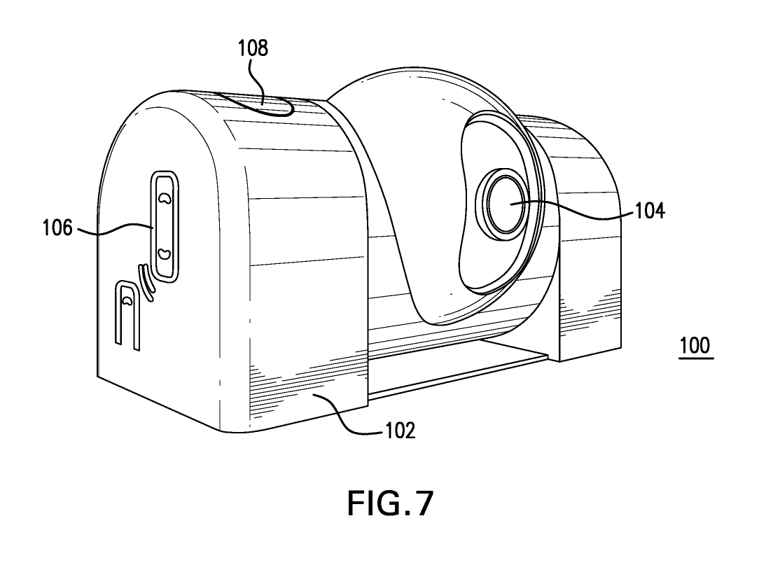

Referring to FIG. 2, camera 104 is more prominently displayed outside housing 102. This is also true in the embodiments shown in FIGS. 3 and 7. While camera 104 is displayed outside housing 102, an important factor is that camera 104 is positioned within the vehicle to view objects within the driver's blind spot field of vision. In many embodiments, such as the embodiments shown in FIGS. 2, 3, and 7 allow camera 104 to rotate in order to expand the camera's viewpoint within housing 102. Camera 104 preferably provides a 135 degree field of vision. The present invention optionally provides audible alerts to the driver, in conjunction with the status indicator 106. Mute button 108 allows the driver to turn on or turn off the audible alerts from device 100 that occur when an object appears in a driver's blind spot. In an example embodiment, pressing and holding mute button 108 allows the driver to modify the volume of the audible alert. In yet another example embodiment, the audible alert increases in volume based on a prescribed time, or directly correlated to the approaching object distance to the driver's vehicle. For example, as the object gets closer to the device 100, the volume of the audible alert increases at a similar rate.

Referring to FIG. 3, status indicator 106 includes visual alerts to notify the driver of an object within his blind spot. As shown in FIGS. 1, 2, 3, and 7, status indicator 106 varies based on the desired output to the driver. In FIGS. 1 and 7, status indicator 106 is the standard multiple vehicle icon used to identify an object in a driver's blind spot. FIGS. 2 and 3 illustrate multiple options for a larger light source to notify the driver of a blind spot alert. Charging port 110 on device 100 allows the battery, or power source, within device 100 to be charged within the vehicle. The battery in device 100 is rechargeable, allowing the driver to remove the present invention from the door panel or other location within the vehicle, insert one end of a charging cord into the charging port 110, and the other end of the charging cord into the vehicle's accessory connection, i.e. the cigarette lighter receptacle, to recharge the present invention for subsequent use.

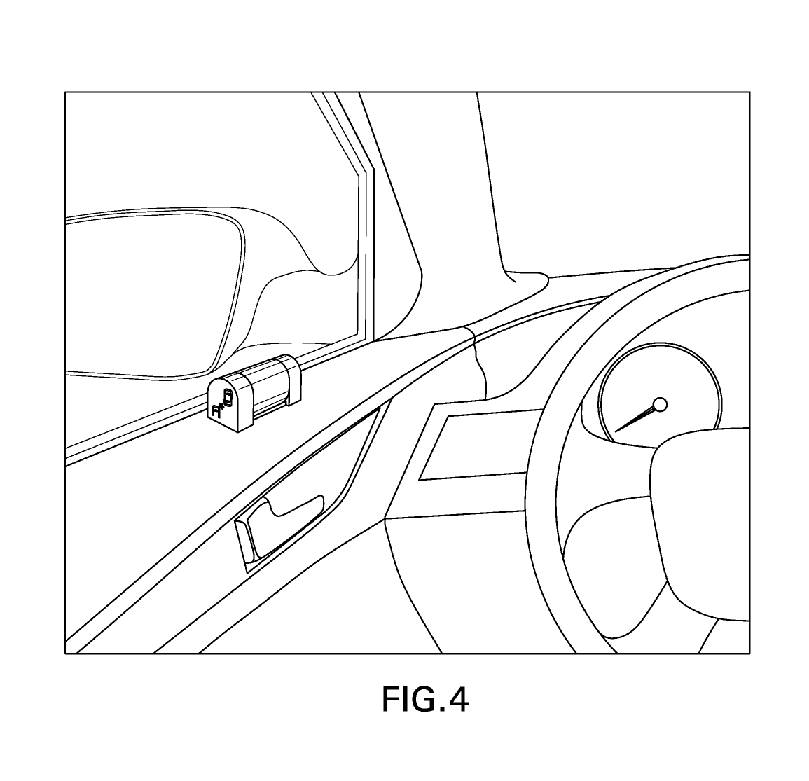

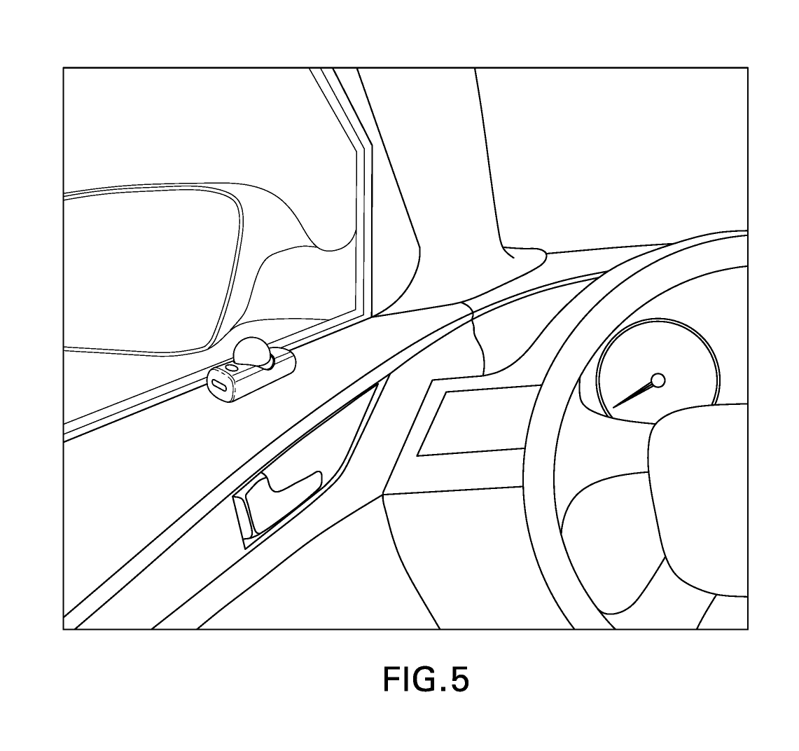

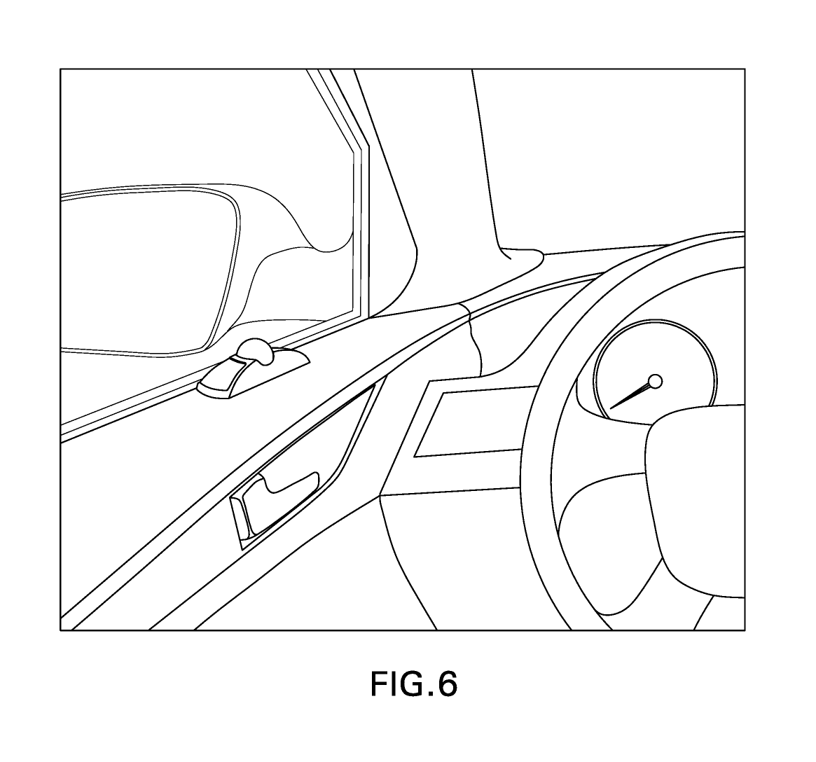

FIGS. 4-6 show the present invention while attached to an interior surface of a vehicle. Keeping the present invention within the vehicle allows the device to be optimally positioned based on the driver's blind spot. Although the blind spot detection device is preferably positioned on the upper door paneling, the device is optionally positioned on other internal vehicle surfaces that provide a clear viewing angle to the driver's blind spot. The present invention is preferably installed on the top of the side door paneling, as depicted in FIGS. 4, 5, and 6. This is the optimal position to notify the driver of an object in his blind spot when the vehicle is in operation.

Referring to FIG. 7, the bottom of the present invention includes a male fitting that engages a female fitting that is secured to the vehicle door surface, e.g., an engageable bracket. The driver optionally installs multiple brackets in their respective vehicles where the driver wants to use the blind spot detection device 100. The driver then removes the device 100 from one car and connects the device to a different car using the male/female fitting connection. Although a male/female fitting is described herein, a myriad or other fittings, brackets, adhesives, hook and loop type fasteners, or other removable connection mechanisms can be used to secure the device to the vehicle door yet allow for simple removal for relocation of the device 100.

In highly preferred embodiments, camera 104 detects objects within its visual field and how far away the objects are from the vehicle. Blind spot detection device 100 includes at least one camera 104, and optionally includes one or more sensors to determine the distance between the object (e.g. other vehicle) and the driver's vehicle. Camera 104 includes technology for viewing objects during night driving, such as infrared and night vision. Camera 104 also detects the proximity of the object to the driver's vehicle directly or using a sensor and microprocessor. The proximity is measured using the camera directly or a sensor within the present invention. Blind spot detection device 100 operates by calculating how close an object or vehicle is to the driver's vehicle, whether or not the object is visible in the driver's field of vision. When an object is detected by camera 104 (or sensor) within a threshold distance to driver's vehicle, status indicator 106, such as an LED, located on blind spot detection device 100 warns the driver of the object's proximity. Blind spot detection device 100 includes software, including a microprocessor, and an algorithm to determine when the visual inputs from camera warrant alerting the driver by flashing the status indicator.

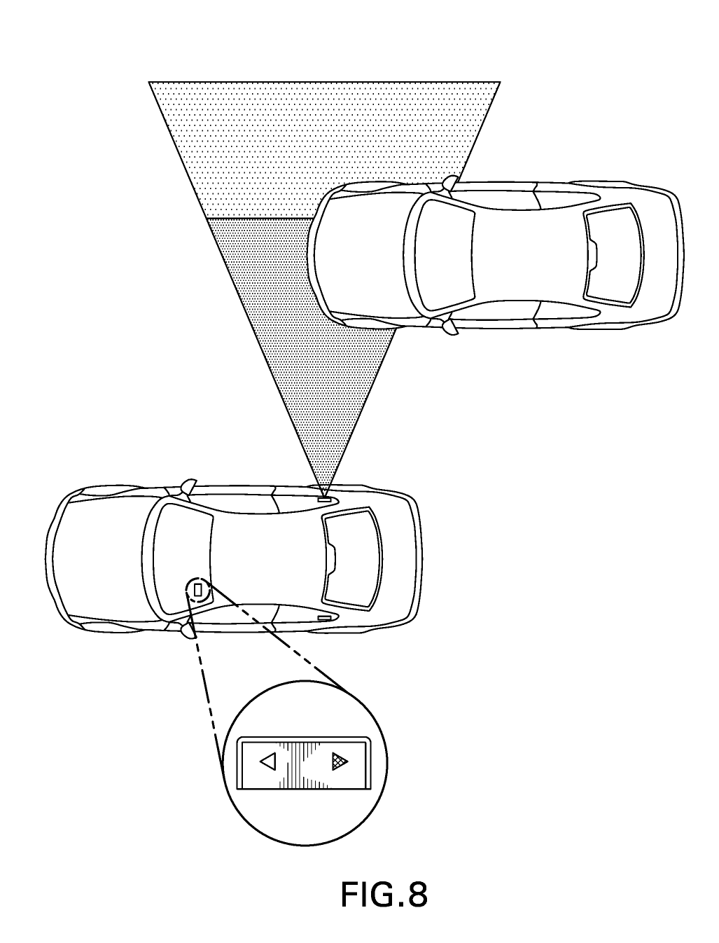

Referring to FIG. 8, an alternative embodiment of the present invention is shown. Here, the present invention consists of two detectors and a single display unit. Preferably, the detectors are placed on each back seat side window. It should be noted that many embodiments do not include the display unit. When a display unit is not equipped, the detectors will produce an audible signal to alert the driver. Preferably the configuration shown in FIG. 8 will be wireless, and is capable of turning itself on and off based on the motion of the car. Each component has preferable dimensions of 3.6 cm×5.2 cm×1.8 cm. Preferably, the present invention will be able to detect an object in a blind spot with at least 90% certainty if the object is within 2.5 meters of the present invention, and with at least 60% certainty if the object is within 5 meters of the present invention. Many embodiments are not capable of detecting objects beyond 7 meters. Preferably, the present invention will turn off after 2 minutes of not moving.

It should be noted that the present invention is not integrated into the vehicle from the OEM. Since the present invention is installed and operated independent of the vehicle's internal computer system and electrical system, the user is not limited to using the device on one vehicle. One benefit this provides is that when the user choses to purchase or lease a new vehicle, or if the user has multiple vehicles, the user may simply remove the present invention from one vehicle and install the device on a new vehicle using the fitting or bracket. This flexibly is a major benefit given the frequency in which drivers change vehicles through the use of leasing programs.

Although device is preferably operated within the vehicle, in another exemplary embodiment, the blind spot detection device is waterproof and able to withstand exterior natural weather changes. This allows the present invention to be configured to other exterior aspects of a vehicle to detect blind spots. Examples include, but are not limited to, a vehicle's spoiler, roof, truck bed railing, body, and window.

In another exemplary embodiment, the present invention is configured to communicate with a cellular device. Such devices include, but are not limited to, cellular telephone, smart phones, tablets, and other personal devices that receive cellular and/or Bluetooth communication. A cellular device is removably mounted within the interior of the vehicle, such as the dashboard or the front windshield, to receive signals from device 100 and alert the driver of objects in his blind spot. In these embodiments, when the present invention detects an object next to the driver's vehicle, i.e. in his blind spot, a signal is sent from the present invention to the cellular device to alert the driver of the object. This provides the driver with a direct stimulus to alert him of the object in his blind spot so he can take the appropriate action as the operator of the vehicle to avoid the object. The alert identifies which side of the vehicle the object is located, right or left. Typically, the driver would not change lanes in traffic to avoid the object.

In yet another exemplary embodiment, the present invention provides the driver with object specific information, such as speed, acceleration, and distance. In yet another exemplary embodiment, the present invention transmits images and/or video from camera 104 to the cellular telephone. This allows the driver to visually observe the object that the present invention is sensing when taking action to avoid contact with the object.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Therefore, it is intended that the disclosure not be limited to the particular embodiments disclosed.

What is claimed is:

1. A blind spot detection device, comprising:
a power source;
a camera operatively connected to the power source;
a memory containing computer-readable instructions for determining whether an object is in a blind spot;
a processor for executing the computer-readable instructions;
a housing having a bottom and an outer surface,
wherein the camera, the memory, and the processor are contained within the housing;
a status indicator disposed on the outer surface of the housing;
a removable attachment device disposed on the bottom of the housing.

2. The blind spot detection device of claim 1, wherein the camera is rotatable.

3. The blind spot detection device of claim 1, wherein the camera has a field of view of 135 degrees.

4. The blind spot detection device of claim 1, wherein the camera can detect infrared light.

5. The blind spot detection device of claim 1, further comprising a proximity sensor.

6. The blind spot detection device of claim 1, wherein the device is mounted on an upper door paneling of an automobile.

7. The blind spot detection device of claim 1, wherein the power source is located within the housing.

8. The blind spot detection device of claim 7, further comprising a charging port integrated into the housing and operatively connected to the power source.

9. The blind spot detection device of claim 8, wherein the power source is a battery.

10. The blind spot detection device of claim 1, wherein the power source is located within an automobile.

11. The blind spot detection device of claim 1, further comprising at least one speaker.

12. The blind spot detection device of claim 1, further comprising a wireless transceiver.

13. A blind spot detection device, comprising:
a first and second detector, each comprising:
a power source,
a motion detector,
a wireless transceiver,
at least one speaker,
at least one status light,
a memory containing computer-readable instructions for detecting proximate objects,
a processor for executing the computer-readable instructions;
a display unit, comprising:
a power source,
a motion detector,
a wireless transceiver,
at least one speaker,
at least one status light,
a memory containing computer-readable instructions for interfacing with the first detector unit and the second detector unit;
a processor for executing the computer-readable instructions;
wherein the display unit is wirelessly connected to the first detector and the second detector.

14. The blind spot detection device of claim 13, wherein the first detector unit and the second detector unit are removably attached to a side of an automobile, and the display unit is removably attached to a windshield of an automobile.

15. The blind spot detection device of claim 13, wherein the display unit can indicate which side a proximate object is located on.

16. The blind spot detection device of claim 13, wherein the device powers off after two minutes of use, and is powered on when motion is detected by the motion detector.

17. A method of notifying a driver of an object in a blind spot of the driver, comprising the steps of:
providing, a blind spot detection device comprising:
a power source,
a camera operatively connected to the power source,
a memory containing computer-readable instructions for determining
whether an object is in a blind spot,
a processor for executing the computer-readable instructions,
a housing having a bottom and an outer surface,
wherein the camera, the memory, and the processor are contained within the housing,
a status indicator disposed on the outer surface of the housing,
a removable attachment device disposed on the bottom of the housing;
placing, the blind spot detection device on an upper door paneling of an automobile;
sensing, by the blind spot detection device if an object is in the blind spot of a driver;
notifying the driver, via the status indicator, that an object is in the blind spot.

18. The method of claim 17, wherein the status indicator notifies a driver by illuminating a light.
